(19) United States
(12) Patent Application Publication
(10) Pub. No.: US 2003/0069857 A1
(43) Pub. Date: Apr. 10, 2003

(54) Proxy system for customer confidentiality

(76) Inventor: Laurence E. Junda, Sherborn, MA (US)

Correspondence Address: David Silverstein, Andover-IP-Law, Suite 300, 44 Park Street, Andover, MA, 01810, US

(21) Appl. No.: 10/314,741

(22) Filed: Dec. 9, 2002

Related U.S. Application Data
(63) Continuation of application No. 09/693,165, filed on Oct. 23, 2000, now abandoned.

(51) Int. Cl. G06F 17/60

(52) U.S. Cl. 705/74

(57) ABSTRACT

A system and method for allowing customers to make purchases and take delivery of goods or services with a desired level of security and confidentiality are disclosed. The system and method enable a customer (user) to effect a purchase and a delivery of goods or services from a merchant without revealing selected real user data to the merchant. In one embodiment, the system includes a proxy user data generator for generating proxy user data corresponding with selected real user data, a database for storing the selected real user data and the corresponding proxy user data, and a purchase authorization request and reply router connectable to a network for routing purchase authorization requests and replies between a merchant and a purchase authorization entity. In another embodiment, the system includes a unit for providing real delivery data corresponding with proxy delivery data to a delivery entity. The system and method are useful for making purchases and taking delivery from either traditional retail outlets or on-line merchants.

### BACKGROUND OF THE INVENTION

1. Field of the Invention

This invention relates generally to information security and confidentiality, and more particularly, to a system and a method for enhancing the security and confidentiality of users who make purchases and take delivery of goods or services. The system and method of the present invention include features that reduce opportunities for unscrupulous individuals or entities to obtain personal user data, and for marketers and others to gather information on the purchasing habits of users, including users who make on-line purchases.

2. Background

When making purchases of goods or services, customers generally have a variety of payment options available to them with varying levels of confidentiality. For example, customers who pay for their purchases using cash can advantageously maintain their anonymity, because they typically are not required to reveal any personal information to complete the transaction. In contrast, customers who pay for their purchases using credit or debit cards must often present valid identification showing their names and/or residential addresses. At the very least, a customer who uses a credit or debit card must reveal his or her card account number to a merchant, who typically transmits the account number to a third party for validating the account and for obtaining authorization to complete the sale. Further, a customer who takes delivery of his or her purchases at a particular location or via a personal computer must also reveal delivery information such as a shipping address or an e-mail address. As a result, credit or debit card account numbers, information about purchased items, names and addresses of the card holders, etc., can be easily correlated by the merchant and/or the third party and used in their own businesses or sold to others.

This problem is especially acute for customers who make on-line purchases; i.e., customers who purchase goods or services from merchant sites over a public distributed network such as the Internet. Not only can merchants and credit or debit card authorities gain access to a customer's personal information during an on-line transaction, but unscrupulous individuals or entities can also intercept the customer's personal information and/or information about the transaction sent over the network. This can lead to a serious invasion of privacy for the customer and weaken the customer's confidence in the Internet as a viable commercial medium. For example, such unscrupulous individuals or entities may attempt to commit credit card fraud by using intercepted credit card account numbers.

Various systems and methods have been proposed for enhancing customer information security. For example, in U.S. Pat. No. 5,420,926 (“the '926 patent”) issued May 30, 1995, to Low et al., a method for making an anonymous non-cash transaction is described. In accordance with that disclosure, a communications exchange is used so that information and/or funds may be transferred without the destination of the transfer knowing the source of the information and/or the funds. Public key encryption is also used so that each party to the transaction and the communications exchange can read only the information the party or the exchange needs for its role in the transaction.

In addition, in U.S. Pat. No. 5,815,665 (“the '665 patent”) issued Sep. 29, 1998, to Teper et al., a method of providing an on-line service to a user over a public network is described. According to that disclosure, an on-line brokering service provides user authentication and billing services to allow users to anonymously and securely purchase on-line services from service provider sites over a distributed public network such as the Internet. After performing a user authentication process, the on-line brokering service transmits an anonymous user ID to the service provider site, which can be used by the service provider for subsequently billing the user. A database of user payment information, e.g., credit card numbers and other personal user data, is maintained at the on-line brokering service site and is neither sent over the distributed public network nor exposed to the service provider sites.

However, the methods for enhancing customer information security described in the '926 and '665 patents have some drawbacks. Specifically, if a method for making on-line purchases is to be fully accepted and utilized by customers, then it not only must guard against unauthorized disclosure and use of customer personal information, but it also must be convenient and easy-to-use. Although both the methods of the '926 and '665 patents may be used for enhancing customer information security, they substantially limit the convenience of making on-line purchases by either requiring customers to install and use specialized software on their computers or requiring customers and merchants to communicate indirectly through a third party.

It would therefore be desirable to have a system and a method for making on-line purchases and taking delivery of the purchases that keeps customers' personal information confidential and secure throughout the purchase or purchase and delivery transactions, while still allowing customers and merchants to communicate with each other over the public network without undue interference from any third party. Such a system would be convenient and easy-to-use for all parties involved in purchase and delivery transactions. It would also be desirable to have a system and a method for enhancing customer information security and confidentiality that can be used for both on-line and conventional purchase and delivery transactions.

### SUMMARY OF THE INVENTION

The present invention provides a system and a method for enabling a customer (referred to herein as a “user”) to make purchases and take delivery of goods or services while keeping some or all of the user's personal information confidential and secure throughout the purchase and delivery transactions. The user's personal information may include, but is not limited to, the user's real name, real residential or shipping address, real e-mail address, and real credit or debit card account number. Before making purchases and/or taking delivery of goods or services, the user obtains proxy personal information for use in place of the user's real personal information during the purchase and/or delivery transactions. Because the user may select the real personal information for which he or she desires corresponding proxy personal information, a desired level of confidentiality and security in purchase and delivery transactions can be achieved

An important feature of the present invention is that the user may utilize the proxy personal information in place of the selected real personal information when making purchases and/or taking delivery of goods or services at both traditional retail outlets and on-line merchant sites. By utilizing the proxy personal information when making purchases, the user can obtain virtually the same level of anonymity that cash-paying customers normally enjoy. Further, by utilizing the proxy personal information when making on-line purchases, the user can avoid any potential leakage of his or her real personal information from the on-line network. Moreover, the user can make on-line purchases utilizing the proxy personal information in the same convenient and easy way that he or she would make such purchases using the real personal information.

Another important feature of the present invention is that the proxy personal information may be provided to the user in the form of a proxy credit or debit card. The user utilizes the proxy credit or debit card in the same way that he or she would use a conventional credit or debit card. However, the user may select beforehand the real personal information that he or she desires to be concealed from the merchant when using the proxy credit or debit card. For example, the user may obtain a proxy credit or debit card that incorporates only a proxy credit or debit card account number corresponding with his or her real credit or debit card account number. Accordingly, when the user utilizes the proxy credit or debit card for making purchases, only his or her real credit or debit card account number is concealed from the merchant. In other embodiments of the present invention, the user may obtain a proxy credit or debit card that incorporates proxy personal information corresponding with, e.g., the user's real name, real residential or shipping address, and/or real e-mail address, thereby allowing the user to conceal additional real personal information from the merchant.

Still another important feature of the present invention is that the user may not only select the real personal information for which he or she desires corresponding proxy personal information, but the user may also select a specific number of purchases that can be made using the proxy personal information, an expiration date for the proxy personal information, and/or a monetary limit for purchases made using the proxy personal information.

The present invention also provides the user with a method for effecting the delivery of the goods or services that conceals the user's real residential or shipping address and/or e-mail address from the merchant. In this embodiment of the present invention, the merchant may deliver goods or services in digital form to the user by utilizing the user's proxy e-mail address. Further, the merchant may deliver goods or services in tangible form to the user by providing the user's proxy residential or shipping address to an accepted delivery service, which obtains the user's corresponding real residential or shipping address and then delivers the goods or services to the user.

In accordance with the present invention, a method of enabling a user to effect a purchase of goods or services from a merchant, without revealing selected real user data to the merchant, includes the steps of generating proxy user data corresponding with the selected real user data; maintaining a database including the selected real user data and the corresponding proxy user data for use in translating the selected real user data into the corresponding proxy user data, and in translating the proxy user data into the corresponding selected real user data; and, routing purchase authorization requests and replies between the merchant and a purchase authorization entity using the selected real user data and the corresponding proxy user data in the database, wherein the requests routed to the purchase authorization entity include the selected real user data, and the replies routed to the merchant include the corresponding proxy user data and do not include the selected real user data.

According to one embodiment of the present invention, the proxy user data can be used for making a selected number of purchases. According to other embodiments, the proxy user data has a selected expiration date and/or a selected monetary limit.

In accordance with another embodiment of the present invention, the method of enabling a user to effect a purchase of goods or services from a merchant, without revealing selected real user data to the merchant, further includes a step of effecting a delivery of the goods or services to the user, wherein the selected real user data does not include either a real name/real shipping address or a real e-mail address.

According to still another feature of the present invention, the goods or services have digital form, and the merchant delivers the digital goods or services directly to the user computer over a network.

According to yet another feature of the present invention, the selected real user data includes a real e-mail address and the corresponding proxy user data includes a proxy e-mail address, and the merchant delivers the digital goods or services to the user utilizing the proxy e-mail address.

In accordance with yet another embodiment of the present invention, the merchant provides the proxy shipping address to a delivery entity, and the method of enabling a user to effect a purchase and delivery of goods or services from the merchant, without revealing selected real user data to the merchant, further includes steps of receiving a request for the real shipping address from the delivery entity, the request including the proxy shipping address; translating the proxy shipping address into the real shipping address using the database; and, providing the real shipping address to the delivery entity for use in subsequently delivering the goods or services to the user.

In accordance with yet another embodiment of the present invention, a method of enabling a user to effect a purchase of goods or services from a merchant using a funding account, includes the steps of generating user account data for the funding account, the user account data having at least one restricted-use attribute; maintaining a database including the user account data; and, routing purchase authorization requests and replies between the merchant and a purchase authorization entity using the user account data in the database, wherein the at least one restricted-use attribute of the user account data is selectable by the user.

According to another feature of the present invention, the at least one restricted-use attribute corresponds with a selected number of purchases that can be funded using the funding account. According to other features, the at least one restricted-use attribute corresponds with a selected period of time during which purchases can be funded using the funding account, and/or a selected monetary limit for the purchases.

In accordance with another embodiment of the present invention, a method of enabling a user to effect a delivery of goods or services from a merchant, without revealing real delivery data to the merchant, includes the steps of generating proxy delivery data corresponding with the real delivery data; maintaining a database including the real delivery data and the corresponding proxy delivery data for use in translating the proxy delivery data into the corresponding real delivery data; and, providing the real delivery data corresponding with the proxy delivery data to a delivery entity, wherein the user provides the proxy delivery data to the merchant, and wherein the merchant provides the goods or services and the proxy delivery data to the delivery entity for subsequent delivery of the goods or services to the user. The delivery data may include the user's name and/or shipping address.

Still further aspects and advantages will become apparent from a consideration of the ensuing description and drawings.

### BRIEF DESCRIPTION OF THE DRAWINGS

The invention will be better understood by reference to the following more detailed description and accompanying drawings in which

FIG. 1 is a block diagram of the general architecture of a system that operates in accordance with one embodiment of the present invention;

FIG. 2 is a flow chart showing the steps performed when a user requests proxy user data from a proxy agent according to one embodiment of the present invention;

FIG. 3 is a flow chart showing the steps performed when a user makes an on-line purchase of goods or services according to one embodiment of the present invention; and

FIG. 4 is a flow chart showing the steps performed when the purchased goods or services are delivered to the user according to one embodiment of the present invention.

### DETAILED DESCRIPTION OF THE INVENTION

The systems and methods of the present invention will be illustrated by an embodiment that provides proxy data to a customer, including a proxy name, a proxy shipping address, a proxy e-mail address, and/or proxy credit or debit account data, to provide customer anonymity from the ordering of goods or services to the delivery of the goods or services. However, varying levels of anonymity may be provided in accordance with the present invention, and delivery is optional. In some embodiments, the customer will be provided with only proxy credit or debit account data; and, in other embodiments, the customer will be provided with complete anonymity of identity and location, from the point of purchase to the point of delivery of the goods or services. It should be understood that this detailed description of the present invention is by way of illustration only, and is not intended to limit its scope.

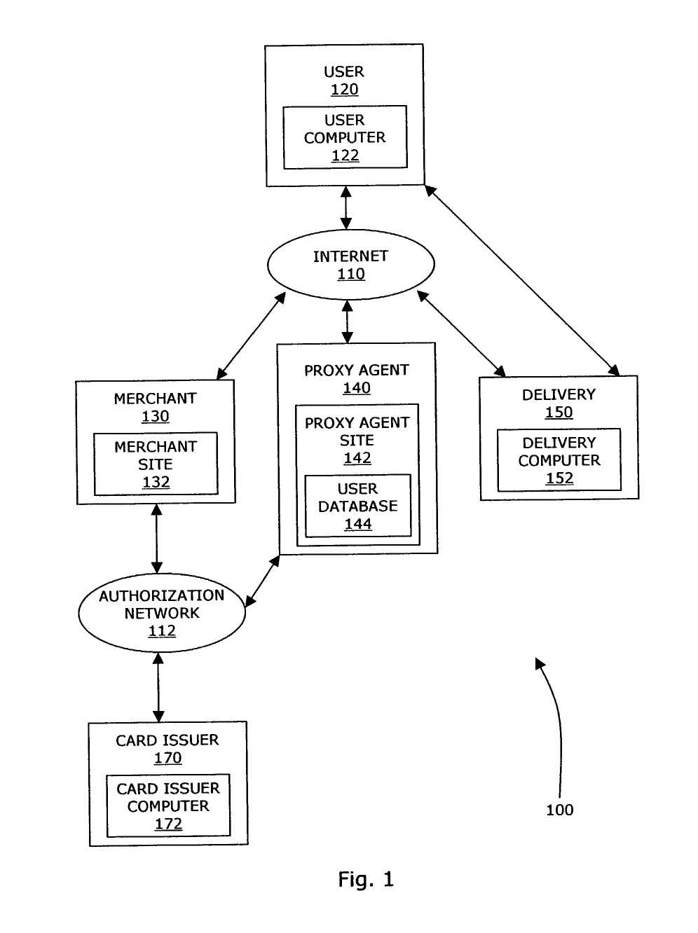

FIG. 1 shows the general architecture of a system 100 that allows a customer to make purchases and take delivery of goods or services while keeping the customer's personal information, e.g., his or her name, shipping address, e-mail address, and/or credit or debit card account number (also known as a “funding account number”), confidential and secure throughout the purchase and the delivery processes.

In this illustrative embodiment, the system 100 includes at least one customer 120 (referred to herein as a “user”) having a user computer 122, at least one merchant 130, at least one delivery provider 150 having a delivery computer 152, and at least one proxy agent 140. Each of the computers 122 and 152 are connectable to an untrusted public network 110 such as the Internet. The system 100 further includes a merchant site 132 and a proxy agent site 142, which are directly accessible sites on the Internet 110. For example, the merchant site 132 and the proxy agent site 142 are accessible on the Internet 110 via a transmission control protocol/Internet protocol (TCP/IP) connection.

In addition, the system 100 includes at least one credit or debit card issuer 170 having a card issuer computer 172 connectable to a network 112 that supports the authorization of credit or debit card transactions. In other preferred embodiments of the present invention, the proxy agent 140 and the card issuer 170 are the same entity. Further, the authorization network 112 may be either a private or a public network, and may also include more than one network.

The card issuer computer 172 communicates with the proxy agent site 142 and the merchant site 132 over the authorization network 112 using a protocol such as any of those conventionally used for processing electronic transactions. Accordingly, software running on the merchant site 132 and the proxy agent site 142 support both the Internet protocol and the banking protocol and can therefore perform the transition in communication from the Internet 110 to the authorization network 112 and vice versa.

The user 120 and the delivery provider 150 utilize the user computer 122 and the delivery computer 152, respectively, to connect to the Internet 110 in any conventional manner. For example, connection between the computers 122 and 152 and the Internet 110 may be made using a modem (not shown) and a telephone line (not shown) via a network service provider (not shown) that is directly connected to the Internet 110. It should be noted that the particular mechanism of how the user computer 122 and the delivery computer 152 form connections with the Internet 110 are not critical to the present invention.

It should also be noted that the user computer 122 and the delivery computer 152 are conventional in design, each typically including a housing that encloses a processor and supporting integrated circuitry, a floppy drive, and a hard disk drive. Each of the computers 122 and 152 also typically includes a keyboard, a mouse, and a monitor for allowing users to enter commands and observe results. For example, the user 120 may enter commands for making purchase selections and observing results such as purchase confirmations while making on-line purchases from the merchant site 132 utilizing the user computer 122.

Specifically, the user computer 122 is capable of running a client application, e.g., a browser, which can initiate connections with one or more host machines (not shown) that contain desired sites, e.g., the merchant site 132 and the proxy agent site 142, pass data back and forth between the user computer 122 and the host machines, and then close the connections. Accordingly, the host machines are capable of running server applications that can accept the connections initiated by the client application through the Internet 110. Again, details of how the host machines, the client applications, and the server applications operate are not critical to the present invention, and may take different forms.

The proxy agent 140 may be a bank or other institution that routes purchase authorization requests and replies between merchants (e.g., the merchant 130) and card issuers (e.g., the card issuer 170). Further, the proxy agent site 142 can communicate with the user computer 122, the merchant site 132, the delivery computer 152, and the card issuer computer 172, and pass data back and forth during the purchase and delivery transactions. Although FIG. 1 shows only one proxy agent 140 and only one proxy agent site 142, it should be understood that the system 100 may include a plurality of such proxy agents and sites. For example, different proxy agents and sites might be provided to serve users residing in different geographical areas.

As mentioned above, the system 100 allows a user to make purchases and take delivery of goods or services while keeping some or all of the user's personal information confidential and secure throughout the purchase and delivery transactions. To this end, the proxy agent site 142 includes at least one user database 144 for storing not only the user's personal information such as his or her real name, real shipping address, real e-mail address, and real credit or debit card account number, but also corresponding proxy data such as a proxy name, a proxy shipping address, a proxy e-mail address, and a proxy credit or debit card account number. In accordance with one preferred embodiment of the present invention that provides the highest level of security and confidentiality, the user 120 makes purchases from the merchant 130 and takes delivery of tangible goods from the delivery provider 150 using only the proxy user data stored in the user database 144, thereby preventing the merchant 130 and others from tracking the user's buying habits and substantially reducing the risk that unscrupulous individuals or entities will intercept, e.g., the user's real credit or debit card account number, and charge unauthorized purchases to his or her account.

For this illustrative embodiment, a procedure will now be described for making purchases and taking delivery of goods or services using the system 100. First, the user 120 registers with the proxy agent 140 for obtaining proxy user data that he or she can use when making purchases and taking delivery of goods or services. The proxy agent 140 then provides the proxy user data to the user 120.

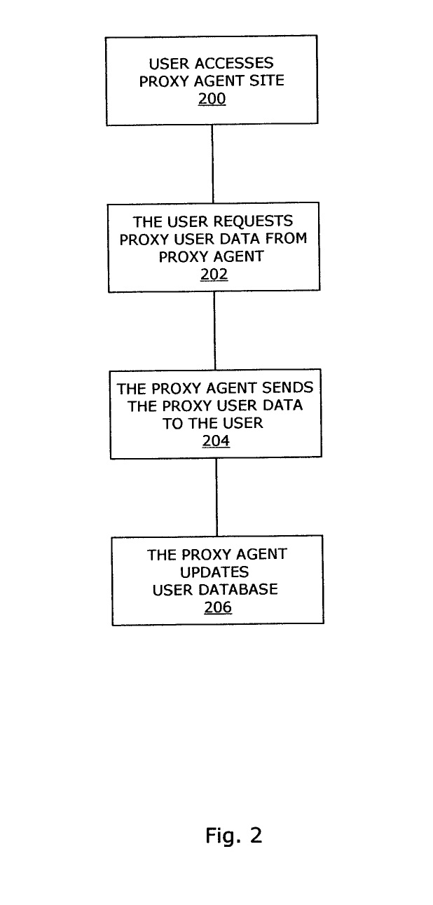

For example, the user 120 registers with the proxy agent 140 according to the procedure shown in FIG. 2. Specifically, the user 120 visits the proxy agent site 142, in block 200, in any conventional manner. For example, the user 120 may utilize an appropriate uniform resource locator (URL) for instructing the web browser running on the user computer 122 to use a particular protocol, e.g., http, to retrieve the home page (not shown) of the proxy agent site 142, e.g., proxy_home.html, located on a particular host machine (not shown), e.g., www.your_bank.com.

Next, the user 120 requests, in block 202, proxy user data from the proxy agent 140. In this illustrative embodiment, the user 120 has a credit or debit card for which he or she requests proxy user data. In a preferred embodiment, the user 120 holds a credit or debit card issued by the proxy agent 140. Accordingly, the user 120 utilizes the home page of the proxy agent 140 to access, e.g., a proxy data request form (not shown). Next, the user 120 fills out the request form including his or her real user data, e.g., real name, real shipping address, and real e-mail address, and then sends the filled-out request form to the proxy agent site 142. It should be understood that the user 120 might alternatively register with the proxy agent 140 without using the user computer 122. For example, the user 120 may utilize the telephone network or regular mail service for providing his or her real user data to the proxy agent 140 during the registration procedure.

In the embodiment wherein the proxy agent 140 has issued the credit or debit card held by the user 120, the user's real credit or debit card account number is already available to the proxy agent 140, and may therefore be easily accessed by the proxy agent 140 for providing a corresponding proxy credit or debit card account number to the user 120. Accordingly, in this preferred embodiment, there is no need for the user 120 to send his or her real credit or debit card account number to the proxy agent 140 over the Internet 110. The software running on the proxy agent site 142 simply utilizes the user's real name, real shipping address, and/or real e-mail address provided on the request form for verifying the existence of the account and determining whether the purchase amount may be charged against the account.

If it is determined, for example, that the user 120 is the holder of a credit or debit card issued by the proxy agent 140, payments have been timely made, and there are funds available on the credit or debit card, then the software on the proxy agent site 142 generates, in block 204, unique proxy user data corresponding with the user's real name, real shipping address, real credit or debit card account number, and real e-mail address, and then provides the generated proxy user data to the user 120 for subsequent use. The user 120 may also be provided with, e.g., an identification number and/or a password for use in making subsequent requests for proxy data. Further, the user 120 may be provided with multiple sets of proxy data, each set corresponding with the user's real data. The proxy user data and the user's identification number/password may be sent to the user computer 122 over the Internet 110 via e-mail or via the client/server applications running on the user computer 122 and the host machine of the proxy agent site 142. It also should be understood that the proxy agent 140 may alternatively utilize the telephone network or regular mail service for providing the proxy user data to the user 120.

In the embodiment of the present invention wherein the credit or debit card held by the user 120 was not issued by the proxy agent 140, the user 120 would also include his or her real credit or debit card account number with the other real user data on the proxy data request form. However, in this embodiment, the server application running on the host machine of the proxy agent site 142 preferably encrypts all of the real user data provided on the proxy data request form before the form is sent from the user computer 122 to the proxy agent site 142, thereby minimizing the chance that an unscrupulous individual or entity will intercept and utilize the user's real credit or debit card account number. Alternatively, the user 120 may utilize the telephone network or regular mail service for providing his or her real credit or debit card account number to the proxy agent 140.

Finally, the software on the proxy agent site 142 updates, in block 206, the user database 144 to include the generated proxy user data and ensure that the generated proxy user data accurately corresponds with the real user data, which is also stored in the database 144 for facilitating translations between the generated proxy user data and the real user data. An illustrative portion of the contents of the updated user database 144, including the real user data and the corresponding proxy user data of the user 120, is shown below in TABLE I.

TABLE I

| | PROXY USER DATA | REAL USER DATA |
|---|---|---|
| USER NAME | AC Member 4325 | Jane Doe |
| USER ADDRESS | AC Proxy Agent | 123 Main Street |
| | Courier—Acct. #4325 | Apt. #2 |
| | Anycity, USA 00000 | Anytown, USA 11111 |
| E-MAIL ADDR. | AC4325@proxyagent.net | jdoe@anyisp.net |
| FUNDING ACC'T. | XXXX XXXX XXXX 4325 | XXXX XXXX XXXX 1234 |

The illustrative proxy user data and real user data corresponding with the funding account information is shown in TABLE I using the symbol, X, which represents any number from 0 to 9. Complete illustrative funding account numbers are not shown in TABLE I so as not to reproduce any funding account numbers currently in use.

As mentioned above, the software on the proxy agent site 142 generates the proxy user data and then may provide the proxy user data to the user computer 122 for subsequent use by the user 120. Significantly, the proxy user data, which may include the proxy name, the proxy shipping address, the proxy e-mail address, and the proxy credit or debit card account number of the user 120, is sent to the user computer 122 directly or via e-mail over the Internet 110. As a result, it is foreseeable that an unscrupulous individual or entity may try to intercept the proxy user data at this point in the transaction and then use the proxy user data to make unauthorized purchases.

However, the present invention reduces the risk of such unauthorized use, because it is not only for securely and confidentially allowing customers to make purchases of goods or services, but it is also for allowing customers to take delivery of the goods or services. For this reason, the generated proxy user data preferably includes the proxy shipping address and/or the proxy e-mail address for use in delivering the purchased goods or services. In the preferred embodiment, the purchased goods or services are delivered only to the real address corresponding with the proxy shipping address or the proxy e-mail address. As a result, even if, e.g., an unscrupulous individual intercepted the proxy user data and made an unauthorized purchase, the purchased goods or services would be delivered to the real address corresponding with the proxy shipping address or the proxy e-mail address, and not to the unscrupulous individual. Such individuals would therefore be deterred from intercepting and using the proxy user data because no benefit would be derived therefrom.

Alternatively, some proxy user data may be sent to the user 120 separately from other proxy user data. For example, the proxy name, the proxy shipping address, and the proxy e-mail address may be sent to the user computer 122 over the Internet 110, while the proxy credit or debit card account number is sent to the user 120 via the telephone network or regular mail.

The present invention also minimizes the risk of unauthorized use of proxy user data by optionally making the proxy user data valid for only a limited number of purchases or requiring the user to make a purchase only within a limited period of time. These important features of the present invention will be described in further detail later in this specification.

This illustrative procedure for making purchases and taking delivery of goods or services also includes communications between the user 120 and the merchant 130, and between the merchant 130 and the proxy agent 140. For example, the user 120 communicates with the merchant 130 for making a purchase. The merchant 130 then requests authorization from the proxy agent 140 for charging the user's credit or debit card account for the purchase, and receives either the requested authorization or a refusal to charge the account from the proxy agent 140. Finally, the merchant 130 provides the user 120 with a confirmation of the purchase transaction.

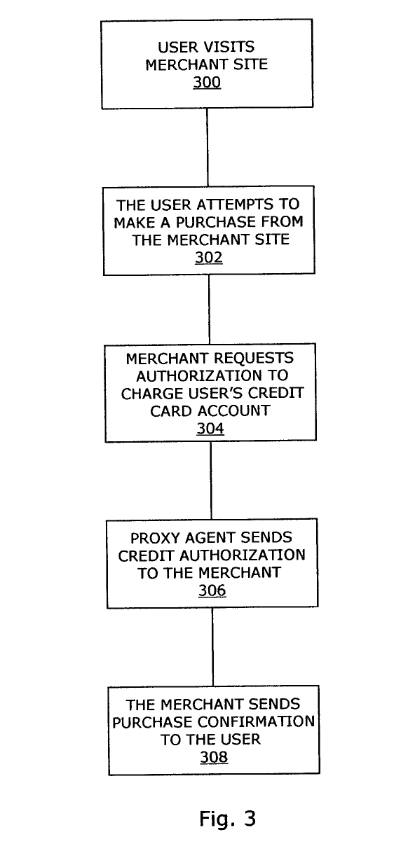

For example, purchases are made and confirmations are provided in accordance with the procedure shown in FIG. 3. Again, the user 120 visits the merchant site 132, in block 300, in any conventional manner. Next, the user 120 utilizes the client application running on the user computer 122 for attempting to make a purchase of goods or services in block 302.

There are many hundreds of merchant sites currently available from which users may make purchases of various types of goods or services. One such merchant site is operated by AMAZON.COM™, Inc., Seattle, Wash., USA. For example, a user may access the AMAZON.COM™ merchant site and select, e.g., books, music, or video products for subsequent purchase. When the user is finished making his or her purchase selections, he or she then typically provides a real name, a real e-mail address, a real shipping address, and a real credit or debit card account number for allowing the AMAZON.COM™ merchant to process and fulfill the purchase order, and then notify the user of the status of the purchase order.

According to the present invention, instead of providing, e.g., the AMAZON.COM™ merchant site with a real name, a real e-mail address, a real shipping address, and a real credit or debit card account number when attempting to make a purchase in block 302, the user 120 provides the merchant site 132 with the proxy user data obtained from the proxy agent 140 in block 204 (see FIG. 2). In this way, the proxy user data acts as a substitute for the user's real data. The system 100 depicted in FIG. 1 may therefore be regarded as a proxy system for maintaining the user's confidentiality during a purchase transaction.

Next, the merchant 130 logs onto the authorization network 112, in block 304, for requesting authorization to charge the user's credit or debit card account for the selected purchase. Accordingly, the proxy user data including the proxy credit or debit card account number is sent over the authorization network 112 from the merchant site 132 to the proxy agent site 142. The software on the proxy agent site 142 then accesses the user database 144 for translating the proxy user data into the real user data, e.g., the proxy credit or debit card account number into the real credit or debit card account number.

If the proxy agent 140 is the bank or other institution that issued the credit or debit card held by the user 120, then the software on the proxy agent site 142 utilizes the real user data obtained from the user database 144 for again verifying, the existence of the account and determining whether the purchase amount may be charged against the account. Alternatively, if the proxy agent 140 is not the bank or other institution that issued the credit or debit card to the user 120, then the software on the proxy agent site 142 translates the proxy user data into the corresponding real user data, e.g., the real credit or debit card account number, utilizing the user database 144, substitutes the proxy user data in the authorization request with the corresponding real user data, and then routes the authorization request to the card issuer 170 over the authorization network 112.

Next, the card issuer 170 sends a response to the authorization request to the proxy agent site 142 over the authorization network 112. The software available through the proxy agent site 142 then substitutes any real user data included in the generated authorization information with the corresponding proxy user data, and then routes the authorization information to the merchant site 132 over the authorization network 112 in block 306. A message including a purchase confirmation is then sent, in block 308, from the merchant site 132 to the user computer 122 directly or via the proxy e-mail address over the Internet 110. The message may also include a delivery confirmation, e.g., a shipping or delivery tracking number. Clearly, if the merchant 130 did not receive the necessary authorization information from the proxy agent 140, then the message sent in block 308 would instead include a refusal of the purchase order.

Advantageously, the user 120 is not required to send any real user data to the merchant 130 at any point in the procedure defined by blocks 300 through 308. Further, the proxy agent 140 does not reveal any of the real user data stored in the user database 144 to the merchant 130 at any point during the purchase transaction. Accordingly, complete user confidentiality in purchase transactions is achieved in this illustrative, non-limiting embodiment of the present invention.

This illustrative procedure for making purchases and taking delivery of goods or services further includes communications between the user 120 and the merchant 130, and also communications between the user 120, the merchant 130, the proxy agent 140, and the delivery provider 150. For example, if the purchased goods or services have digital form, then they are sent from the merchant site 132 to the user computer 122 directly or via e-mail over the Internet 110. Alternatively, if the purchased goods or services have tangible form, then the merchant 130 provides them to the delivery provider 150, which then delivers the goods or services to the user 120.

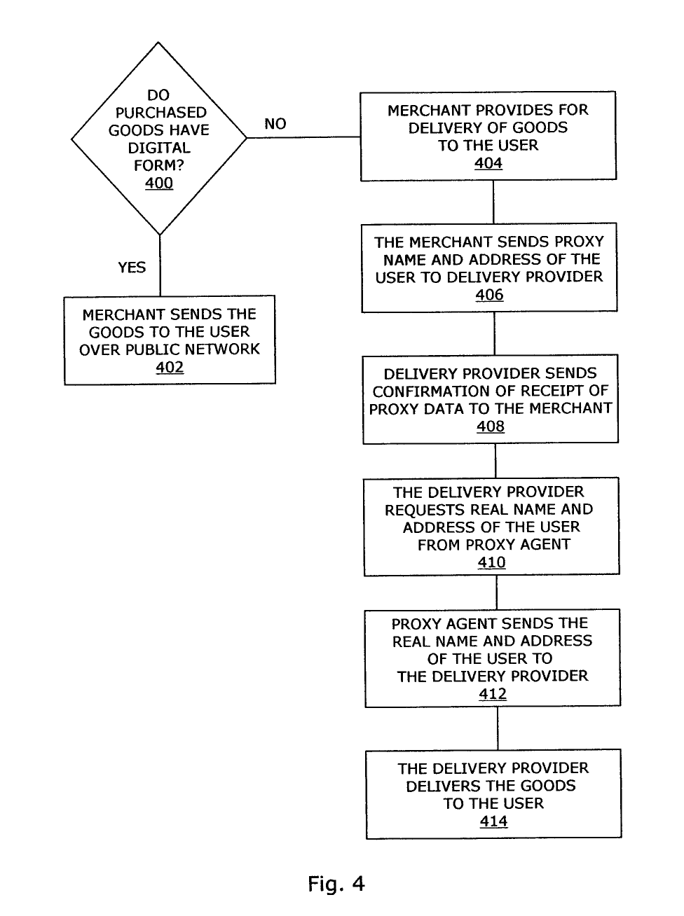

For example, the purchased goods or services are delivered to the user 120 in accordance with the procedure shown in FIG. 4. First, it is determined, in block 400, whether or not the goods or services have digital form. If the goods or services have digital form, then they are sent to the user 120 over the Internet 110, in block 402, by directly downloading them from the merchant site 132 to the user computer 122. For example, digital goods or services can be directly downloaded in a conventional manner via the client and server applications running on the user computer 122 and the host machine of the merchant site 132. Alternatively, the digital goods or services may be sent from the merchant 130 to the user 120 over the Internet 110 as, e.g., an attachment to an e-mail message.

It should be noted that if the digital goods or services are sent from the merchant 130 to the user 120 as an attachment to an e-mail message, then the e-mail message is sent by the merchant 130 to the proxy e-mail address, which was provided to the merchant site 132 along with the other proxy user data in block 302 (see FIG. 3). For example, the e-mail message may be directed to the proxy agent site 142 via the proxy e-mail address. The software on the proxy agent site 142 may then access the user database 144 for translating the proxy e-mail address into the real e-mail address. Finally, the proxy agent site 142 may redirect the e-mail message to the user computer 122. Alternatively, the merchant 130 may direct the e-mail to the user's real e-mail address, if the user 120 so desires.

Alternatively, if the goods or services have tangible form, then the merchant 130 provides the goods or services to the delivery provider 150 in block 404, who subsequently delivers the goods or services to the user's real shipping address. It should be noted that details of how the merchant 130 provides the goods or services to the delivery provider 150 are not critical to the present invention.

Specifically, when the merchant 130 provides the tangible goods or services to the delivery provider 150, the merchant 130 includes the proxy name and the proxy shipping address of the user 120. For example, a message may be generated and sent, in block 406 from the merchant site 132 to the delivery computer 152 including the proxy name and the proxy shipping address of the user 120. A message confirming receipt of the user's proxy name and proxy shipping address may then be sent, in block 408, from the delivery computer 152 to the merchant site 132. Alternatively, the merchant 130 may utilize the telephone network or regular mail service for providing the user's proxy name and proxy shipping address to the delivery provider 150.

Next, the delivery provider 150 visits the proxy agent site 144, in block 410, over the Internet 110 or a private network, and requests the real user data that corresponds with the proxy user data sent in block 406. The software on the proxy agent site 142 then accesses the user database 144 for obtaining the user's real name and real shipping address, and then generates and sends a message back to the delivery computer 152, in block 412, including this real user data. Alternatively, the delivery provider 150 may utilize the telephone network or regular mail service for obtaining the user's real name and real shipping address from the proxy agent 140.

In this illustrative embodiment, the merchant 130 might also send the user's proxy e-mail address to the delivery provider 150 in block 406; or, the proxy agent 140 might also send the user's proxy e-mail address to the delivery provider 150 in block 412. This would allow the delivery provider 150 to send an e-mail message to the user 120 for confirming the upcoming delivery of the tangible goods or services. The delivery provider 150 then delivers the tangible goods or services to the user's real shipping address, in block 414.

As described above, all of the user's proxy data, which includes all of the data the user 120 requires to make a purchase and take delivery of the purchase, may be sent through the Internet 110 during the execution of at least two steps in the procedure of the present invention. For example, all of the user's proxy data may be sent from the proxy agent site 142 to the user computer 122 over the Internet 110 in block 204 (FIG. 2). Similarly, all of the proxy data may be sent from the user computer 122 to the merchant site 132 over the Internet 110 in block 302 (FIG. 3) when the user attempts to make an on-line purchase. Even though this proxy data does not include any real user data, an unscrupulous individual or entity may try to intercept the proxy user data at these steps in the procedure and attempt to make an unauthorized purchase using the proxy user data. It is important to note that the merchant 130, especially an on-line merchant, has no way of knowing whether or not the proxy user data was provided to him or her by a bona fide customer, i.e., the user 120.

For this reason, in another preferred embodiment of the present invention, the proxy user data provided by the proxy agent 140 to the user 120 is preferably valid for making only a limited number of purchases, e.g., one and only one purchase. If the user 120 attempts to make an on-line purchase within a relatively short period of time after receiving the proxy user data from the proxy agent 140, then the probability that an unscrupulous individual or entity would intercept the proxy user data and then attempt to make a purchase with the proxy user data within this short period of time is reduced.

However, it is possible that the user 120 may wait a significant period of time before attempting to make a purchase after he or she receives the proxy user data from the proxy agent 140. The proxy user data is therefore more preferably valid not only for a limited number of purchases, but also for a limited period of time, e.g., one to twenty-four hours. Therefore, even though the user 120 may decide not to make any purchases after receiving the proxy user data, an unscrupulous individual or entity would not be able to make unauthorized use of the proxy user data after the expiration of the one to twenty-four hour period.

The number of purchases that can be made using the proxy user data, and the expiration period of the proxy user data, may be set at the time the proxy agent 140 provides the proxy user data to the user 120. Alternatively, the user 120 may specify both the number of purchases he or she wishes to make and the expiration period in the proxy data request form in block 202 (FIG. 2). The software on the proxy agent site 142 would then store the specified number of purchases and the specified expiration period in the user database 144 along with the rest of the proxy user data. Further, while routing purchase authorization requests and replies between merchants and card issuers, the proxy agent may also check the user database 144 for determining whether the specified number of purchases has been exceeded or whether the specified time period has expired.

Numerous advantages can be derived from using the proxy system 100 and the procedures of the present invention. For example, the present invention allows users to make purchases and take delivery of the purchases securely and confidentially, especially when making on-line purchases over an untrusted distributed public network such as the Internet. Security is enhanced during the purchase and delivery transactions by only allowing delivery of the purchased goods or services directly to the user computer 122, to the user's e-mail address, or to the user's shipping address. Security is further enhanced by providing proxy user data that can be used only for a limited number of purchases and/or only for a limited period of time. Providing confirmations of transactions at various steps in the procedures still further enhances security. For example, the merchant site 132 provides a confirmation of an on-line purchase at block 308 (FIG. 3); and, the delivery provider 150 provides confirmation of the receipt of proxy user data and an upcoming delivery to the user's real shipping address in blocks 408 and 414, respectively.

In addition, user confidentiality is enhanced during the purchase and delivery transactions by providing proxy user data in place of the user's real name, real shipping address, real e-mail address, and/or real credit or debit card account number. Because the merchant 130 has access to only the proxy user data during the purchase and delivery transactions, it is impossible for him or her to identify the user 120 and track the user's buying habits. This gives users who make credit and/or on-line purchases virtually the same anonymity that cash-paying customers normally enjoy.

In addition, in many embodiments, none of the user 120, the merchant 130, the delivery provider 170, or the card issuer 170 require specialized software on his or her computing system when using the proxy system 100 of the present invention. This is typically the case when the proxy system 100 is used with conventional distributed public networks and conventional authorization networks.

In addition, the proxy system 100 is both convenient and easy-to-use. For example, after obtaining proxy user data from the proxy agent 140, the user 120 visits merchant sites, e.g., the merchant site 132, and makes on-line purchases in the conventional manner with the exception that the user 120 utilizes the proxy user data to make the purchases instead of his or her real user data. The merchant 130 also communicates with the user 120 in the same conventional manner with the exception that he or she receives the proxy user data instead of the real user data. Further, the merchant 130 communicates with the proxy agent 140 as he or she would with a conventional credit or debit card authorization service.

Having described one embodiment, numerous alternative embodiments or variations might be made. Specifically, it was described that the user requests and receives proxy user data from the proxy agent over an untrusted public network such as the Internet. However, this is merely one illustrative example. Further, it should be understood that the manner in which the user requests and obtains the proxy user data from the proxy agent is not critical to the invention. For example, the user might alternatively request and obtain the proxy user data from the proxy agent over a trusted private network or a telephone network. In these alternative embodiments, the probability of an unscrupulous individual or entity intercepting either the real user data or the proxy user data would be further reduced.

In addition, it was described that a message is generated and sent from the merchant site directly to the user computer for confirming a purchase transaction. However, this is also merely one illustrative example. The purchase confirmation generated at the merchant site might alternatively pass through the proxy agent site before being sent to the user computer. As a result, the proxy agent would be able to maintain a record of the purchase transaction and store the record in the user database along with the user's real data and proxy data. The user may then access these records for keeping track of his or her purchases made using the proxy user data.

In addition, it was described above that the merchant provides tangible goods or services to a particular delivery provider for subsequent delivery to the user's real shipping address. However, this is merely another illustrative example. The user may alternatively specify the delivery provider from a list of delivery providers that are approved for receiving proxy user data and obtaining corresponding real user data from the proxy agent. This would further enhance the security of the user's personal information.

In addition, it was described above that the delivery provider visits the proxy agent site over the Internet or a private network, and requests the real user data that corresponds with the proxy user data. However, when the delivery provider requests a translation of the proxy shipping address into the real shipping address over a private network, specialized software may be required on a computing system available to the delivery provider. To avoid the need for specialized software, the merchant may alternatively provide the tangible goods and the proxy shipping address to any delivery provider, who then delivers the tangible goods with the proxy shipping address to the proxy agent. Next, the proxy agent may provide the tangible goods and the corresponding real shipping address to the delivery provider specified by the user, who then delivers the tangible goods to the user's real shipping address. As a result, the delivery provider is not required to request a translation of the proxy shipping address, and, therefore, does not require specialized software.

In addition, it was described above that the user visits the merchant site directly over the untrusted public network. However, this is also merely another illustrative example. The user may alternatively visit the merchant site through an “anonymizer” web site such as that provided by ANONYMIZER™ Inc., La Mesa, Calif., USA. This would further enhance confidentiality in on-line purchase transactions by allowing the user not only to prevent his or her personal information from being received by merchant sites, but also, e.g., the IP address of his or her computer on the Internet.

In addition, it was described that the user may specify both the number of purchases he or she wishes to make using the proxy user data and the expiration period of the proxy user data. The user may also specify a monetary limit for purchases that can be made using the proxy user data.

In addition, it was described above in the illustrative procedure that the proxy user data provided by the proxy agent is used in making on-line purchases. However, this is merely one illustrative example. Users may alternatively request and obtain proxy user data from the proxy agent, and then use the proxy user data for making conventional purchases from merchants, e.g., direct purchases from traditional retail outlets. For example, the proxy agent may provide the proxy user data for use with a proxy credit or debit card. In this way, users may make direct credit or debit purchases with virtually the same anonymity that cash-paying customers normally enjoy. The features of restricting the number and the monetary limit of purchases that can be made with the card, and the feature of setting the expiration date of the card, may also be available for making conventional purchases. A proxy credit or debit card may also be provided that includes the user's real personal information, e.g., his or her real credit or debit card account number, but also has the features for restricting use of the card.

In addition, it was described above that the user registers with the proxy agent for obtaining proxy user data that he or she can use when making purchases and taking delivery of goods or services. However, this is also merely one illustrative example. The user may, e.g., register with the proxy agent once, thereby providing the proxy agent with his or her real user data. The user may then request and obtain new proxy user data corresponding with the real user data from the proxy agent as many times as he or she wishes for subsequently making purchases, without having to re-register with the proxy agent each time. As described above, the user may be provided with, e.g., an identification number and/or a password for use in making subsequent requests for proxy data.

In addition, it was described above that the user makes purchases from the merchant and takes delivery of the purchases using only the proxy user data stored in the user database. It was also described that the user database stores not only the user's personal information such as his or her real name, real shipping address, real e-mail address, and real credit or debit card account number, but also corresponding proxy data such as a proxy name, a proxy shipping address, a proxy e-mail address, and a proxy credit or debit card account number. However, this is merely another illustrative example. In a preferred embodiment, the real user data and the corresponding proxy user data stored in the user database includes all of the user data required to effect the purchase and delivery of goods or services. Some purchase and delivery transactions may therefore require different amounts of user data or different types of user data to effect the transaction.

Further, the user may alternatively request and obtain proxy user data corresponding with only a selected amount of real user data, even if this proxy user data alone would be insufficient for effecting the purchase and delivery of goods or services. For example, the user may decide to request and obtain proxy user data corresponding with only his or her real credit or debit card account number. Accordingly, the proxy agent would generate a proxy credit or debit card account number and store both the proxy card account number and the corresponding real card account number in the user database. The proxy agent would then route purchase authorization requests and replies between the merchant and the card issuer while revealing the real card account number only to the card issuer and concealing the real card account number from the merchant. In this way, the user may select different levels of security and confidentiality for different purchase and delivery transactions.

The present invention has been described in detail including the preferred embodiments thereof. However, it should be appreciated that those skilled in the art, upon consideration of the present disclosure, may make modifications and/or improvements on this invention and still be within the scope and spirit of this invention as set forth in the following claims.

What is claimed is:

1. A method of enabling a user to effect a purchase of goods or services from a merchant without revealing selected real user data to the merchant, comprising the steps of:
(a) generating proxy user data corresponding with the selected real user data;
(b) maintaining a database including the selected real user data and the corresponding proxy user data for use in translating the selected real user data into the corresponding proxy user data, and in translating the proxy user data into the corresponding selected real user data; and
(c) routing purchase authorization requests and replies between the merchant and a purchase authorization entity using the selected real user data and the corresponding proxy user data in the database,
wherein the requests routed to the purchase authorization entity include the selected real user data, and the replies routed to the merchant include the corresponding proxy user data and do not include the selected real user data.

2. The method as recited in claim 1, further including a step of effecting a delivery of the goods or services to the user, wherein the selected real user data includes at least one of a real name, a real shipping address, and a real e-mail address, and the corresponding proxy user data includes at least one of a proxy name, a proxy shipping address, and a proxy e-mail address.

3. The method as recited in claim 2,
wherein the goods or services have digital form,
wherein the merchant delivers the digital goods or services to the user as an e-mail transmission using the proxy e-mail address, and
further including the step of routing the e-mail transmission from the merchant to the user using the proxy e-mail address and the corresponding real e-mail address, wherein the step of routing includes the substeps of
receiving the e-mail transmission including the digital goods or services, the e-mail transmission being received at the proxy e-mail address,
accessing the database for translating the proxy e-mail address into the corresponding real e-mail address, and
sending the e-mail transmission to the corresponding real e-mail address.

4. The method as recited in claim 2, wherein the merchant provides the goods or services, the proxy name, and proxy shipping address to a delivery entity, and the method further includes the steps of
receiving a request for the real name and real shipping address corresponding with the proxy name and proxy shipping address from the delivery entity,
translating the proxy name and proxy shipping address into the real name and real shipping address using the database, and
providing the real name and real shipping address to the delivery entity,
whereby the delivery entity delivers the goods or services to the user.

5. The method as recited in claim 2, wherein the merchant provides the goods or services and the proxy name/proxy shipping address to a first delivery entity, and the method further includes the steps of
receiving the goods or services and the proxy name/proxy shipping address from the first delivery entity,
translating the proxy name/proxy shipping address into the real name/real shipping address using the database, and
providing the goods or services and the real name/real shipping address to a second delivery entity,
whereby the second delivery entity delivers the goods or services to the user.

6. The method as recited in claim 5, wherein the first delivery entity and the second delivery entity are the same delivery entity.

7. The method as recited in claim 1, wherein the proxy user data generated in step (a) includes at least one restricted-use attribute.

8. The method as recited in claim 7, wherein the restricted-use attribute is selectable by the user.

9. The method as recited in claim 7, wherein the restricted-use attribute corresponds with at least one of a selected number of purchases that can be authorized by the purchase authorization entity, a selected period of time during which purchases can be authorized by the purchase authorization entity, or a selected monetary limit for purchases that can be authorized by the purchase authorization entity.

10. The method as recited in claim 1, further including the steps of
receiving a request for the proxy user data from the user, the request including the selected real user data, and
providing the proxy user data corresponding with the selected real user data to the user.

11. The method as recited in claim 10, wherein the user is further provided with at least a user ID and/or a password for use in making subsequent requests for proxy user data.

12. The method as recited in claim 10, wherein the request for the proxy user data is received via a network, and the proxy user data is provided to the user via a network.

13. The method as recited in claim 10, wherein the user is provided with more than one set of proxy user data corresponding with the selected real user data.

14. The method as recited in claim 13, wherein the maintaining in step (b) includes updating the database to include each set of proxy user data corresponding with the selected real user data.

15. The method as recited in claim 1, wherein the selected real user data includes real funding account data, and wherein the corresponding proxy user data includes proxy funding account data.

16. The method as recited in claim 1, wherein the routine in step (c) includes the substeps of
(c1) receiving a purchase authorization request from the merchant, the purchase authorization request including the proxy user data,
(c2) translating the proxy user data into the corresponding selected real user data using the database,
(c3) substituting the proxy user data in the purchase authorization request with the corresponding selected real user data, and routing the purchase authorization request to the purchase authorization entity,
(c4) receiving a purchase authorization reply from the purchase authorization entity, the purchase authorization reply including the selected real user data, and
(c5) substituting the selected real user data in the purchase authorization reply with the corresponding proxy user data, and routing the purchase authorization reply to the merchant.

17. The method as recited in claim 1, wherein the user purchases the goods or services from the merchant by visiting a merchant site using a computer, the merchant site and the computer being connectable to a network.

18. The method as recited in claim 1, wherein the database including the selected real user data and the corresponding proxy user data is stored in a storage device on a computer connectable to a network.

19. The method as recited in claim 1, wherein the routine in step (c) is performed over at least one network.

20. A method of enabling a user to effect a purchase of goods or services from a merchant using a funding account, comprising the steps of:
(a) generating user account data for the funding account, the user account data having at least one restricted-use attribute;
(b) maintaining a database including the user account data; and
(c) routing purchase authorization requests and replies between the merchant and a purchase authorization entity using the user account data in the database,
wherein the restricted-use attribute corresponds with at least one of a number of purchases that can be funded using the funding account, a period of time during which purchases can be funded using the funding account, and/or a monetary limit for purchases that can be funded using the funding account.

21. The method as recited in claim 20, wherein the at least one restricted-use attribute of the user account data is selectable by the user.

22. The method as recited in claim 20, wherein the routing in step (c) includes a substep of determining whether any use restrictions of the user account data have been violated.

23. The method as recited in claim 1, further including steps of tracking purchases made using the user data stored in the database and storing information related to the tracked purchases in the database.

24. The method as recited in claim 20, further including steps of tracking purchases made using the user data stored in the database and storing information related to the tracked purchases in the database.

25. A method of enabling a user to effect a delivery of goods or services from a merchant without revealing real delivery data to the merchant, comprising the steps of:
(a) generating proxy delivery data corresponding with the real delivery data:
(b) maintaining a database including the real delivery data and the corresponding proxy delivery data for use in translating the proxy delivery data into the corresponding real delivery data; and
(c) providing the real delivery data corresponding with the proxy delivery data to a delivery entity,
wherein the user provides the proxy delivery data to the merchant, and
wherein the merchant provides the goods or services and the proxy delivery data to the delivery entity for subsequent delivery of the goods or services to the user.

26. A system for enabling a user to effect a purchase of goods or services over a distributed network without sending selected real user data over the distributed network, for use with at least one merchant site accessible on the distributed network, each merchant site being connectable to an authorization network for making purchase authorization requests and receiving replies thereto, at least one user computer connected to the distributed network, each user computer running at least one client application for accessing the at least one merchant site on the distributed network, and at least one purchase authorization entity, each purchase authorization entity being accessible on the authorization network and capable of sending replies over the authorization network in response to the purchase authorization requests, the system comprising:
a proxy user data generator for generating proxy user data corresponding with the selected real user data;
a database for storing the selected real user data and the corresponding proxy user data, for use in translating the selected real user data into the corresponding proxy user data and in translating the proxy user data into the corresponding selected real user data; and
a purchase authorization request/reply router connectable to the authorization network for routing purchase authorization requests/replies between each merchant site and each purchase authorization entity using the selected real user data and the corresponding proxy user data stored in the database.

27. A system for enabling a user to effect a purchase of goods or services over a distributed network using a funding account, for use with at least one merchant site accessible on the distributed network, each merchant site being connectable to an authorization network for making purchase authorization requests and receiving replies thereto, at least one user computer connected to the distributed network, each user computer running at least one client application for accessing the at least one merchant site on the distributed network, and at least one purchase authorization entity, each purchase authorization entity being accessible on the authorization network and capable of sending replies over the authorization network in response to the purchase authorization requests, the system comprising:
a user account data generator for generating user account data for the funding account, the user account data having at least one restricted-use attribute;
a database for storing the user account data; and
a purchase authorization request/reply router connectable to the authorization network for routing purchase authorization requests/replies between each merchant site and each purchase authorization entity using the user account data stored in the database,
wherein the restricted-use attribute corresponds with at least one of a number of purchases that can be funded using the funding account, a period of time during which purchases can be funded using the funding account, or a monetary limit for purchases that can be funded using the funding account.

28. A system for enabling a user to effect a delivery of goods or services from an on-line merchant without revealing real delivery data to the on-line merchant, for use with at least one merchant site accessible on a distributed network, at least one user computer connected to the distributed network, each user computer running at least one client application for accessing the at least one merchant site on the distributed network, and at least one delivery entity, the system comprising:
a proxy delivery data generator for generating proxy delivery data corresponding with the real delivery data, for use by the user;
a database for storing the real delivery data and the corresponding proxy delivery data, for use in translating the proxy delivery data into the corresponding real delivery data; and
a unit for receiving a request for the real delivery data corresponding with the proxy delivery data, and for providing the real delivery data in response to the request, for use by the delivery entity in delivering the goods or services to the user.

29. A system for enabling a user to effect a delivery of goods or services over a distributed network via e-mail without sending a real e-mail address over the distributed network, for use with at least one merchant site accessible on a distributed network, and at least one user computer connected to the distributed network, each user computer running at least one client application for accessing the at least one merchant site on the distributed network, the system comprising:
a proxy e-mail address generator for generating a proxy e-mail address corresponding with the real e-mail address, for use by the user;
a database for storing the real e-mail address and the corresponding proxy e-mail address, for use in translating the proxy e-mail address into the corresponding real e-mail address; and
an e-mail router connectable to the distributed network for routing e-mail between each merchant site and the user computer, wherein the merchant site sends the goods or services over the distributed network using the proxy e-mail address and the e-mail router routes the goods or services sent by the merchant site to the user using the corresponding real e-mail address.
